(19) United States
(12) Patent Application Publication
(10) Pub. No.: US 2025/0385447 A1
(43) Pub. Date: Dec. 18, 2025

(54) Terminal, Terminal Assembly, Connector and Automobile

(71) Applicants: Tyco Electronics (Suzhou) Ltd., Suzhou City (CN); Tyco Electronics (Shanghai) Co., Ltd., Shanghai (CN)

(72) Inventors: Kai (Rik) Chen, Suzhou (CN); Feng (Charles) Wan, Shanghai (CN); Limin Gao, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 19/240,493

(22) Filed: Jun. 17, 2025

(30) Foreign Application Priority Data
Jun. 18, 2024 (CN) 202410784421.1

(51) Int. Cl. H01R 11/05; H01R 4/18; H01R 4/48

(52) U.S. Cl. CPC H01R 11/05; H01R 4/184; H01R 4/4811; H01R 2201/26

(57) ABSTRACT

A terminal includes a cylindrical body, a crimping portion, a plurality of resilient pieces, and a sleeve. The crimping portion is disposed at an end of the cylindrical body and crimps a wire onto the terminal. The plurality of resilient pieces extend from an other end of the cylindrical body and electrically connect a mating terminal inserted between the resilient pieces. The sleeve is sleeved on outer sides of the cylindrical body and the resilient pieces. The sleeve has at least one set of protrusions. Each protrusion protrudes from a side wall of the sleeve towards the cylindrical body. Each protrusion abuts against the cylindrical body and aligns with each other in a circumferential direction of the sleeve adjusting a coaxiality between the sleeve and each of the cylindrical body and the resilient pieces.

### CROSS-REFERENCE TO RELATED APPLICATION

This application claims the priority of Chinese Patent Application No. CN 202410784421.1 filed on Jun. 18, 2024.

### FIELD OF THE INVENTION

The present disclosure relates to a field of mechanical electronics and, more particularly, to a terminal, a terminal assembly, a connector, and an automobile.

### BACKGROUND OF THE INVENTION

A connector is a device used to connect two active devices to transmit current or signals. A connector may simplify an assembly process of an electronic product and also simplify a mass production process of the electronic products. A connector is easy to repair, and if an electronic component fails, the failed component may be quickly replaced with a connector installed. With an advancement of technology, the electronic product equipped with a connector may use updated electronic components, replacing old electronic components with new and better performing ones for easy upgrading. A connector may enhance a flexibility of product design when designing and integrating a new product, as well as when composing a system with electronic components. Therefore, connectors are widely used in fields such as transportation, healthcare, aerospace, military, and home appliances.

In terminals of some connectors, the interference fit between an outer surface of a body of the terminal and an inner surface of a sleeve ensures the coaxiality between the sleeve and each of the body of the terminal and the resilient pieces of the terminal. However, this interference fit is highly sensitive to changes in the size and shape of the terminal and sleeve. Due to machining errors in the body of the terminal and/or the sleeve typically disposed on the body of the terminal, it is difficult to ensure the coaxiality between the sleeve and each of the body and the resilient pieces, resulting in an offset between the sleeve and each of the body and the resilient pieces, ultimately causing the mating terminal to be unable to be inserted smoothly into the resilient pieces and/or the body, or even causing the mating terminal to be unable to be inserted into the resilient pieces and/or the body. This results in an unstable electrical connection between the terminal and the mating terminal, and may even results in failing to form any electrical connection between the terminal and the mating terminal, causing difficulty in assembly of the terminal and an insufficient holding force between the terminal and the mating terminal. Therefore, it is necessary to provide a terminal that is easy to assemble and has a large holding force.

### SUMMARY OF THE INVENTION

A terminal includes a cylindrical body, a crimping portion, a plurality of resilient pieces, and a sleeve. The crimping portion is disposed at an end of the cylindrical body and crimps a wire onto the terminal. The plurality of resilient pieces extend from an other end of the cylindrical body and electrically connect a mating terminal inserted between the resilient pieces. The sleeve is sleeved on outer sides of the cylindrical body and the resilient pieces. The sleeve has at least one set of protrusions. Each protrusion protrudes from a side wall of the sleeve towards the cylindrical body. Each protrusion abuts against the cylindrical body and aligns with each other in a circumferential direction of the sleeve adjusting a coaxiality between the sleeve and each of the cylindrical body and the resilient pieces.

### BRIEF DESCRIPTION OF DRAWINGS

The invention will now be described by way of example with reference to the accompanying figures, of which:

FIG. 1 is a perspective view of a terminal without a sleeve according to an embodiment;

FIG. 2 is a perspective view of the terminal of FIG. 1 disposed with a sleeve according to an embodiment;

FIG. 3 is a perspective view of a terminal assembly according to an embodiment;

FIG. 4 is a perspective view of the terminal of FIG. 1 taken along line IV-IV in FIG. 2, with a protrusion abutting against the cylindrical body;

FIG. 5 is a front view of the terminal of FIG. 1 taken along line IV-IV in FIG. 2, showing the protrusion abutting against the cylindrical body; and

FIG. 6 is a front view of the terminal of FIG. 1 taken along line VI-VI in FIG. 3, showing a plug inserted into the resilient pieces.

### DETAILED DESCRIPTION

In order to make the purpose, technical scheme, and advantages of the present disclosure more clear, the following is a detailed explanation of the present disclosure, combined with specific embodiments and referring to the attached drawings.

However, it should be understood that these descriptions are only illustrative and not intended to limit the scope of the present disclosure. In the following detailed description, for ease of interpretation, many specific details are elaborated to provide a comprehensive understanding of the embodiments of the present disclosure. However, it is evident that one or more embodiments may also be implemented without these specific details. In addition, in the following explanation, the description of well-known technology is omitted to avoid unnecessary confusion with the concept of the present disclosure.

The terms used herein are only for describing specific embodiments and are not intended to limit the present disclosure. The term “comprising” used herein indicates the existence of features, steps and operations, but does not exclude the existence or addition of one or more other features.

In the case of using expressions such as “at least one of A, B, and C, etc.” or the like, it should generally be interpreted in accordance with the meaning of the expressions that those skilled in the art usually understand (for example, “a system with at least one of A, B, and C” should comprise but not be limited to a system with only A, a system with only B, a system with only C, a system with A and B, a system with A and C, a system with B and C, and/or a system with A, B, C, etc.).

All terms used here (comprising technical and scientific terms) have the meanings commonly understood by those skilled in the art, unless otherwise defined. It should be noted that the terms used herein should be interpreted as having a meaning consistent with the context of this specification, and should not be interpreted in an idealized or overly rigid manner.

The features disclosed in this disclosure will become more apparent in the following detailed description in conjunction with the accompanying drawings, where similar reference numerals identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

The accompanying drawings form a part of the specification and illustrate the present disclosure and, together with the description, further serve to explain the principles of the disclosure and to enable those skilled in the relevant art to manufacture and use the embodiments described herein.

The present disclosure discloses a terminal 100, a terminal assembly 1000 comprising the terminal 100, a connector comprising the terminal assembly 1000, and an automobile comprising the connector.

The terminal 100, as shown in FIGS. 1-3 and 5, is configured to be connected between a wire and a mating terminal 200. The terminal 100 comprises a cylindrical body 110, a crimping portion 120, resilient pieces 130, and a sleeve 140.

As shown in FIGS. 1-5, the crimping portion 120 is constructed in a form of four wings and is disposed at an end of the cylindrical body 110 so as to crimp the wire onto the terminal 100, thereby forming an electrical connection between the wire and the terminal 100. Resilient pieces 130, shown in FIGS. 1 and 6, are configured to extend from the other end of the cylindrical body 110 so as to electrically connect the mating terminal 200 inserted between the resilient pieces 130. As shown in FIG. 6, the resilient pieces 130 comprise two separate resilient pieces 130 that are tapered in a direction away from the other end of the cylindrical body 110 and face towards each other. Each of the two separate resilient pieces 130 is constructed with an arc-shaped cross section. However, those skilled in the art should understand that the present disclosure is not limited to this. The number of the resilient pieces 130 may be three or more, and the cross section of each of the resilient pieces 130 may also be constructed in other suitable shapes to form a stable and reliable electrical connection with the mating terminal 200.

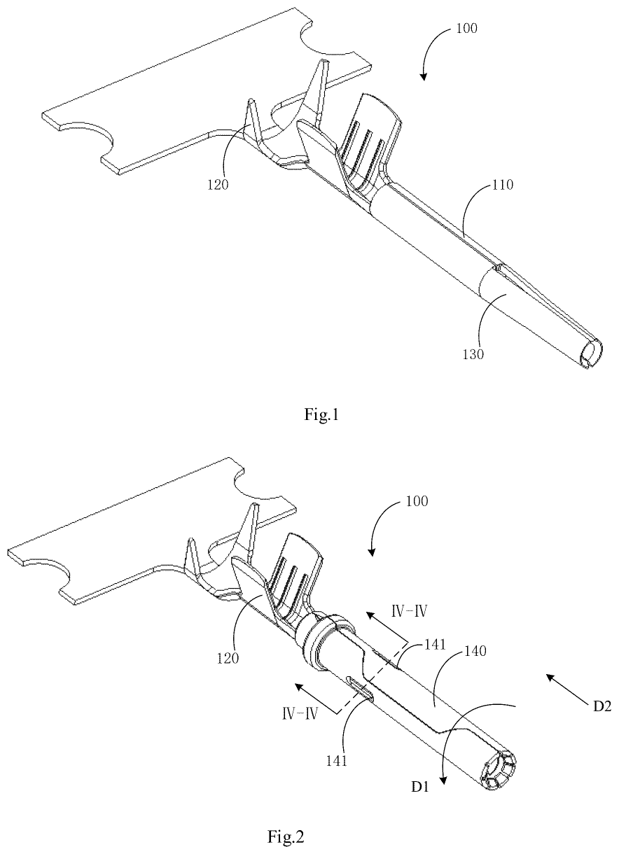

As shown in FIGS. 2-4, the sleeve 140 is sleeved on outer sides of the cylindrical body 110 and the resilient pieces 130 so as to prevent excessive expansion and deformation of the resilient pieces 130 towards the outer side when a plug 230 of the mating terminal 200 is inserted between the resilient pieces 130. Thus, the sleeve 140 functions to limit the deformation or displacement of the resilient pieces 130, thereby forming a stable and reliable abutment or electrical connection between the resilient pieces 130 and the plug 230 of the mating terminal 200. The sleeve 140 comprises at least one set of protrusions 141, shown in FIGS. 2-5, each of which is configured to protrude from a side wall of the sleeve 140 towards the cylindrical body 110. Each protrusion 141 abuts against the cylindrical body 110 and aligns with each other in a circumferential direction D1 of the sleeve 140 so as to adjust a coaxiality between the sleeve 140 and each of the cylindrical body 110 and the resilient pieces 130, thereby effectively avoiding machining errors in the cylindrical body 110 of the terminal 100 and/or the sleeve 140 disposed on the cylindrical body 110 of the terminal 100 causing an offset between the sleeve 140 and each of the cylindrical body 110 and the resilient pieces 130, so as to allow the plug 230 of the mating terminal 200 to be smoothly inserted between the resilient pieces 130 or into the cylindrical body 110 and thus form a stable and reliable electrical connection with the terminal 100, facilitating the assembly of the terminal 100 and the mating terminal 200, and also advantageously increasing a holding force between the terminal 100 and the mating terminal 200.

Although a set of protrusions 141 are shown in FIGS. 2-5 as being located near the middle of the sleeve 140, a plurality of sets of protrusions 141 may also be disposed on other portions of the sleeve 140 so as to adjust the coaxiality between the sleeve 140 and each of the cylindrical body 110 and the resilient pieces 130. The at least one set of protrusions 141 may comprise a plurality of sets of protrusions 141 distributed in an axial direction D2 of the sleeve 140 so as to enhance the holding force between the resilient pieces 130 and the mating terminal 200, further ensuring to form a stable and reliable electrical connection between the resilient piece 130 and the mating terminal 200.

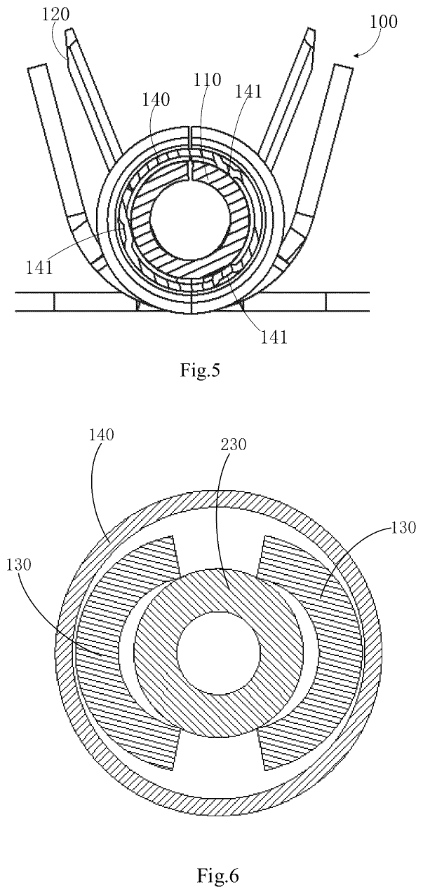

The protrusions 141 may be configured to extend in the circumferential direction D1 and/or the axial direction D2 of the sleeve 140. The distances by which the plurality of protrusions 141 are configured to protrude towards the cylindrical body 110 may be adjustable (see FIGS. 4 and 5) so as to adjust the coaxiality between the sleeve 140 and each of the cylindrical body 110 and the resilient pieces 130. Although each of the protrusions 141 is constructed as a convex rib extending in the axial direction D2 in FIGS. 2-4, the present disclosure is not limited to this, and the protrusions 141 may be constructed in any suitable shape.

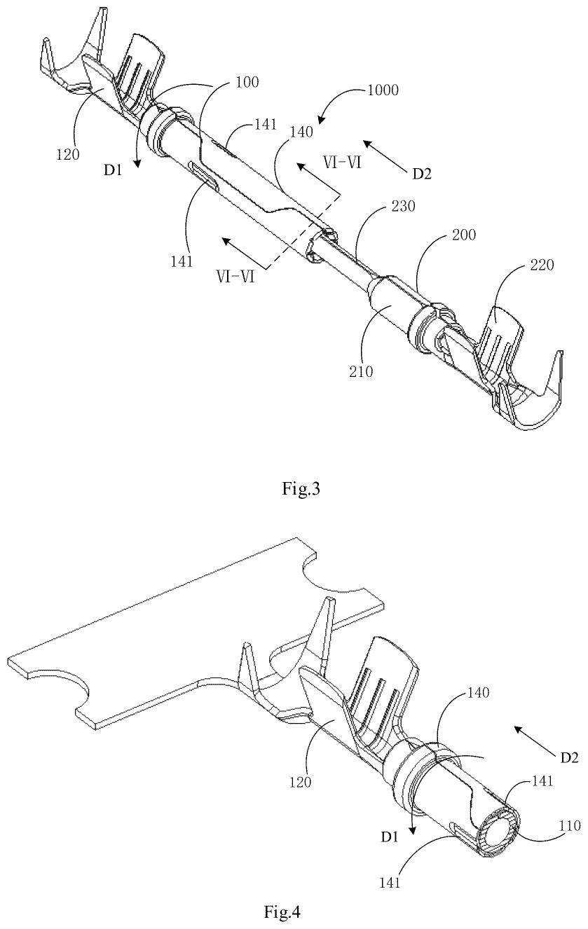

A terminal assembly 1000 according to one embodiment of the present disclosure is shown in FIG. 3. The terminal assembly 1000 comprises the terminal 100 and the mating terminal 200. As shown in FIG. 3, the mating terminal 200 comprises a cylindrical mating body 210, a mating crimping portion 220 configured in a form of four wings, and a cylindrical plug 230. The mating crimping portion 220 is disposed at an end of the mating body 210 for crimping another wire onto the mating terminal 200. The plug 230 is configured to extend from the other end of the mating body 210 so as to be inserted between the resilient pieces 130, so that the terminal assembly 1000 electrically connects the wire with the another wire. FIG. 6 shows the state where the plug 230 is inserted between the resilient pieces 130 and into the sleeve 140. It may be seen from FIG. 6 that the good coaxiality between the plug 230 and each of the resilient pieces 130 and the sleeve 140 is ensured due to the provision of the protrusions 141.

As described above, a detailed description of the embodiments of the present disclosure has been provided in conjunction with the accompanying drawings. It should be noted that implementations not shown or described in the accompanying drawings or the text of the specification are all forms known to the person skilled in the art that the present disclosure pertains to and have not been explained in detail. In addition, the above definitions of each of the components are not limited to the various specific structures, shapes, or methods mentioned in the embodiments, which may be easily modified or replaced by the person skilled in the art.

It should also be noted that in specific embodiments of the present disclosure, unless otherwise expressly stated, the numerical parameters in this specification and the attached claims are approximate values that may be changed based on the desired characteristics obtained by the content of the present disclosure. Specifically, all numbers used in the specification and claims to represent the dimensions, range conditions, etc. of the composition should be understood as being modified by the term “approximately” in all cases. In general, the meaning of the expression refers to an inclusion of a specific number of ±10% changes in some embodiments, ±5% changes in some embodiments, ±1% changes in some embodiments, and ±0.5% changes in some embodiments.

The person skilled in the art may understand that the features recorded in various embodiments and/or claims of the present disclosure may be combined or incorporated in a plurality of ways, even if such combinations or incorporations are not explicitly recorded in the present disclosure. Specifically, without departing from the spirit and teachings of the present disclosure, the features recorded in various embodiments and/or claims of the present disclosure may be combined and/or incorporated in plurality of ways. All these combinations and/or incorporations fall within the scope of the present disclosure.

The specific embodiments described above provide further detailed explanations of the purpose, technical scheme, and beneficial effects of the present disclosure. It should be understood that the above explanations are only specific embodiments of the present disclosure and are not intended to limit the present disclosure. Any modifications, equivalent replacements, improvements, etc. made within the spirit and principles of the present disclosure should be comprised in the protection scope of the present disclosure.

1. A terminal, comprising:
a cylindrical body;
a crimping section disposed at an end of the cylindrical body;
a plurality of resilient pieces extending from an other end of the cylindrical body for receiving a mating terminal inserted between the resilient pieces; and
a sleeve sleeved on outer sides of the cylindrical body and the resilient pieces, the sleeve has at least one set of protrusions, each protrusion protrudes from a side wall of the sleeve towards the cylindrical body, each protrusion abuts against the cylindrical body and aligns with each other in a circumferential direction of the sleeve adjusting a coaxiality between the sleeve and each of the cylindrical body and the resilient pieces.

2. The terminal of claim 1, wherein the at least one set of protrusions extends in the circumferential direction and/or an axial direction of the sleeve.

3. The terminal of claim 2, wherein a distance that each protrusion protrudes towards the cylindrical body is adjustable to adjust the coaxiality between the sleeve and each of the cylindrical body and the resilient pieces.

4. The terminal of claim 3, wherein each protrusion is a convex rib extending in the axial direction.

5. The terminal of claim 1, wherein the at least one set of protrusions includes a plurality of sets of protrusions distributed in an axial direction of the sleeve enhancing a holding force between the resilient pieces and the mating terminal.

6. The terminal of claim 5, wherein the plurality of resilient pieces are two separate resilient pieces each tapered in a direction away from the other end of the cylindrical body and facing towards each other.

7. The terminal of claim 6, wherein each separate resilient piece has an arc-shaped cross section.

8. A terminal assembly, comprising:
a terminal including a cylindrical body, a crimping portion, a plurality of resilient pieces, and a sleeve, the crimping portion is disposed at an end of the cylindrical body, the plurality of resilient pieces extend from an other end of the cylindrical body, the sleeve is sleeved on outer sides of the cylindrical body and the resilient pieces, the sleeve has at least one set of protrusions, each protrusion protrudes from a side wall of the sleeve towards the cylindrical body, each protrusion abuts against the cylindrical body and aligns with each other in a circumferential direction of the sleeve adjusting a coaxiality between the sleeve and each of the cylindrical body and the resilient pieces; and
a mating terminal including a mating body, a mating crimping portion, and a plug, the mating crimping portion is disposed at an end of the mating body, and the plug extends from the other end of the mating body and is inserted between the resilient pieces, the resilient pieces electrically connecting plug inserted between the resilient pieces.

9. The terminal assembly of claim 8, wherein the terminal is connected between a wire and the mating terminal.

10. The terminal assembly of claim 8, wherein the at least one set of protrusions extends in the circumferential direction and/or an axial direction of the sleeve.

11. The terminal assembly of claim 10, wherein a distance that each protrusion protrudes towards the cylindrical body is adjustable to adjust the coaxiality between the sleeve and each of the cylindrical body and the resilient pieces.

12. The terminal assembly of claim 11, wherein each protrusion is a convex rib extending in the axial direction.

13. The terminal assembly of claim 8, wherein the at least one set of protrusions includes a plurality of sets of protrusions distributed in an axial direction of the sleeve enhancing a holding force between the resilient pieces and the mating terminal.

14. The terminal assembly of claim 13, wherein the plurality of resilient pieces are two separate resilient pieces each tapered in a direction away from the other end of the cylindrical body and facing towards each other.

15. The terminal assembly of claim 14, wherein each separate resilient piece has an arc-shaped cross section.
